(19) United States
(12) Patent Application Publication
(10) Pub. No.: US 2002/0033460 A1
(43) Pub. Date: Mar. 21, 2002

(54) Methods and apparatus for recording and reproducing a subwavelength resolution ionization radiation images and medium for it

(76) Inventors: Lev Nagli, Petach Tikva (IL); Igor Fridland, Holon (IL)

Correspondence Address: Benjamin J. Hauptman, LOWE HAUPTMAN GILMAN & BERNER, LLP, 1700 Diagonal Road, Suite 310, Alexandria, VA, 22314, US

(21) Appl. No.: 09/817,356

(22) Filed: Mar. 22, 2001

Related U.S. Application Data
(60) Provisional application No. 60/191,255, filed on Mar. 22, 2000.

(51) Int. Cl. G03B 42/08

(52) U.S. Cl. 250/583

(57) ABSTRACT

A method for writing in and reading out a sub-micron quality radiation image of the object under test, comprising: irradiation the object under test to produce the object patterned ionization radiation passed through the object; irradiating photostimulable material by the patterned ionization radiation having passed through the object creating pattern concentration of the electron and hole centers; photostimulation the material with stimulating light to create electron hole recombination to create photostimulation patterned luminescence; and collecting of the stimulating luminescence light to produce an electronic image signal.

### FIELD OF THE INVENTION

The present invention relates to the art of recording and reproducing images corresponding to ionizing radiation and in particular to method and reusable media for X-ray image acquisition using near field scanning for high resolution imaging.

### BACKGROUND OF THE INVENTION

In one aspect the present invention relates to a method for recording and reproducing an ionization radiation image by using photostimulable phosphors particularly to highly transparent single crystal photostimulable phosphors.

In another aspect the present invention refers to sub-wavelength resolution reading out method of radiation image storage into photostimulable phosphor.

Most X-ray imaging systems today use photographic plates to acquire and store images. Such systems have many shortcomings including their use of non-recyclable media, generation of toxic wastes and waiting time for development.

It is known in the art to the method of acquire and store X-ray images using certain types of phosphor storage materials instead of film.

The disclosures of U.S. Pat. Nos. 3,859,527, 4,258,264, 4,261,854, 4,926,047, 5,180,610, 5,028,509, 5,206,514 and 5,227,097 and “Luminescent Alkali Halide Crystal Memory Elements”, by I. K. Plyavin, V. P. Objedkov, G. K. Vale, R. A. Kalhnin and L. E. Nagli in “Luminescence of Crystals, Molecules, and Solutions, the Proceedings of the International Conference on Luminescence, Leningrad, USSR, August 1972”, edited by Fred Williams, published by Plenum Press, New York, 1973, are incorporated herein by reference. These documents disclose materials, apparatus and methods relating to photo-stimulation. In particular, they describe irradiating a doped alkali-halide crystal with a pattern of ionizing radiation to create local, relatively stable, electron centers and hole centers according to the pattern of the radiation. Read-out of the pattern is performed by photo-stimulating the electron centers by irradiating the crystal with light of a suitable wavelength. At the results of such stimulating the electrons recombine with holes, which causes light to be emitted from the crystal, effectively reproducing the stored radiation pattern. Typically, the stimulation light is red or infrared light.

The above mentioned references also disclose image read-out apparatus. The method of read-out includes serially scanning the crystal with a light beam, such as a laser beam and sensing the emitted light with an optical sensor, generally by a photomultiplier (PM). It should be noted that the stimulation wavelength and the photostimulated luminescence wavelength are far enough apart so measurement of the emitted light can be effected without interference from the stimulation light.

The main shortcomings of this radiation imaging method as well as method based on photographic materials is relatively low image resolution.

Continual efforts have been made to increase special resolution of optical imaging. Special resolution in conventional optics is diffraction limited and not exceed about λ/2 since they operate under classical diffraction limit. Although various devices, such as electron microscopes, are available for imaging objects with a high resolution, such prior devices have required that the samples to be observed must be inserted into a high vacuum. Samples generally must be conductive and (or) frequently require the deposition of an external metallic layer onto them. These techniques are expensive and may result in serious damages or destruction of the sample particularly when biological materials are being imaged.

As disclosed papers for example in: A. E. Ash and G. Nichollas “Super-Resolution Aperture Scanning Microscope”, Nature, vol. 237, p, 510, 1972, D. Pohl, W. Denk, and M. Lanz, “Optical Stethoscopy: Image Recording With Resolution λ/20” and in U.S. Pat. No. 466,747 field Aug. 3, 1983, in U.S. Pat. No. 4,917,462 field Aug. 16, 1989, and in U.S. Pat. No. 5,410,151 field Jul. 15, 1993 near field scanning microscopy (NSOM) is a technique for receiving object imaging with resolution much better than λ by means of light beam which is directed through a very small aperture. An image is of the object is formed by means of scanning in raster-like fashion relative to the object. The width of the aperture is made substantially smaller than the wavelength of the light (e.g., λ/10), and the object to be imaged is held in the near field of the aperture. Within this near field imaging technique resolution is defined by geometry projection of aperture on object surface instead of by the wavelength.

Most of the work in the field of NSOM is centered on the use of the aperture as an illuminator, with light transmitted through the sample being collected in the far field by an objective. Small aperture may be used also as a receiver light transmitted through small portion of the sample. Another approach in NSOM as disclosed in paper of A. Harootunian, E. Betyzig, M. Isaacson, and A. Lewis “Super-resolution fluorescence near-field scanning optical microscopy” Appl. Phys. Letters vol. 49, p. 674, 1986. In this method small aperture is used as an illuminator for exciting fluorescence into small section of the sample and collection luminescence image of the sample or as a receiver of the luminescence light from the sample.

The disclosures of U.S. Pat. Nos. 5,513,168, 5,605,779, 5,654,131 and in papers, S. Jiang, J. Ichihasi, H. Monobe, M. Fujihira, and M. Mohtsu, “Highly localized photochemical processes in LB films of photochromic material by using a photon scanning tunneling microscope”, Opt. Commun. Vol. 61, p.173, 1994, M. Hamano and M. Irie, “Rewritable near field optical recording on photochromic thin films”, Japan J. Appl. Phys, Vol. 35, p. 1764, 1996. These documents disclose materials, apparatus and methods relating to optical memory materials. In particular they describe photochromic materials, which exhibit two different isomers reversibly transformed from one into the other on irradiation with light of appropriate wavelength. These isomer posses different absorption spectra and information is read out using a contrast between the irradiated and not irradiated portions of the material. When the colored portion of the material is exposed to light with wavelength causing a reverse photochromic reaction the erasing of information is carried out.

In the paper T. Tsujioka and M. Irie, “Fluorescence readout of near-field photochromic memory”, Appl. Optics, Vol. 37, p. 4419, 1998 is disclosed method and photochromic material where the reading out of the written information is possible in fluorescence light from one of the isomers.

One of the problems of photochromic materials is their low contrast between two isomers used for writing information and therefore low signal-to-noise ratio in such a devices. Another problem of this kind of materials is their low dynamic range of the optical signal that may be written in these photochromic materials therefore very low imaging contrast may be received. Still another problem of these materials is their low absorption coefficient of an ionization radiation and therefore small affectivity for radiation image storage. Still another shortcoming of known in the art of near field imaging method and used materials for this method realization is impossibility to image the inner structure of the small opaque object to be tasted.

### SUMMARY OF THE INVENTION

It is an object of the present invention is to provide methods and an apparatus for writing and reading out the radiation image of a tested object with sub-micron resolution. A father object of the present invention is to provide a reusable material having sufficient quality to be used for storage and recovering of the radiation image with sub-wavelength resolution. The present invention is based on combining two different methods: (i) the radiation image storage in photostimulable phosphor; (ii) the near-field fluorescence readout method, and using high optical quality activated single crystal as a photostimulable phosphor.

According to one aspect of the present invention there is provided a method for writing in and reading out a sub-micron quality radiation image of an object under test, comprising:

ionization radiation means for irradiation the object under test to produce the object patterned ioinization radiation passed through the object;

photostimulable material having been irradiated by the patterned ionization radiation having passed through the object create pattern concentration of the electron and hole centers;

photostimulation the material with stimulating light to create electron hole recombination to create photostimulation patterned luminescence; and

collecting of sad stimulating luminescence light to produce an electronic image signal.

According to further features in preferred embodiments of the invention described below, the photostimulable material is transparent to the photostimulation and to the photostimulation luminescence light.

According to still further features in the described preferred embodiments the transparent photostimulable material is a doped single crystal having the following empirical formula:

AⁱBⁱⁱ:aM

wherein:

Aⁱ is an alkaline metal selected from the group consisting of, LI, Na, K Cs, and Rb,

Bⁱⁱ is a halogen selected from the group consisting of F, CI, Br or I;

M is an activator ion selected from the group consisting of Eu²⁺ Ge²⁺ Sn²⁺ Pb²⁺, Tl⁺, In⁺, Ga⁺, and Ag⁺, Cu⁺,

and concentration a of the activator M is between 0.1 and 1 m%

According to still further features in the described preferred embodiments the transparent photostimulable material is thin surface activated single crystal.

According to still further features in the described preferred embodiments the surface activation of the transparent single crystal is achieved by diffusion of the activator M.

According to still further features in the described preferred embodiments manufacturing the surface activated transparent single crystal comprising the steps of:

a) vacuum vapor-depositing activating metal ion M on surface of an transparent phosphor as described in the present invention; and

b) heating vapor-deposited stimulable single crystal in the vacuum or under a protective gas atmosphere up to a temperature slightly less than the melting point of the stimulable single crystal

c) heating stimulable single crystal and vapors of the activator or activator salts in the vacuum or under a protective gas atmosphere up to a temperature slightly less than the melting point of the stimulable single crystal.

According to still further features in the described preferred embodiments the photostimulation means comprising:

a) laser beam source emitted the stimulation light within the spectral range of 500 nm to 700 nm

b) near field light delivery system to stimulate of the photostimulable material

According to still further features in the described preferred embodiments the near field stimulation light delivery system comprising:

a) mask incorporating at list one aperture having diameter within the range of 1 nm to 5 nm or

b) pipette with tapered tip with opening aperture diameter within the range of 1 nm to 5 nm or

c) optical fiber with taped output tip with diameter within the range of 1 nm to 5 nm.

According to still further features in the described preferred embodiments the photostimulation means further comprising steps of controllable positioning the photostimulable crystal irradiated surface to near-field distance z from the aperture or the fiber output tip.

According to still further features in the described preferred embodiments the method comprising further step of x-y plane scanning of the photostimulable crystal with respect to the aperture or the fiber output tip.

According to still further features in the described preferred embodiments the method further comprising:

a) current closed loop circuit to keep the preserve the near field distance between the aperture and the photostimulable crystal

b) X-Y stage with X-Y stage driver to move the photostimulable crystal and to produce raster pattern of photostimulation luminescence radiation image of the object.

According to still further features in the described preferred embodiments the method comprising:

a) means for converting photostimulation luminescence light to electric signal

b) means for visualization the electrical signal.

According to still further features in the described preferred embodiments the means for converting photostimulation luminescence light to electric signal is photomultiplier (PM) which is located to opposite side of an irradiated surface of the photostimulable crystal to collect photostimulation luminescence light rays which propagate in this direction through the transparent photostimulable crystal.

According to still further features in the described preferred embodiments the PM is placed to the back side of the photostimulable crystal perpendicularly to the irradiated surface of the photostimulable crystal to collect photostimulation luminescence light rays which propagate through the transparent photostimulable crystal under as through optical waveguide.

According to still further features in the described preferred embodiments the PM is placed in the focus of non-imaging light collection device to collect photostimulation luminescence light rays which propagate through the photostimulable crystal.

According to still further features in the described preferred embodiments the sub-micron object to be tested is a lithographic mask which is placed on close proximity of activated surface of the photostimulable crystal aid the photostimulable crystal is irradiated through the object.

According to still further features in the described preferred embodiments the sub-micron object to be tested is a biological molecular object which is placed on close proximity of an activated surface of the photostimulable crystal and the photostimulable crystal is irradiated through the object.

According to still further features in the described preferred embodiments the sub-micron object to be tested is a gap between computer hard disk and magnetic head and the ionization radiation source, the gap and the photostimulable crystal are positioned in the line which is the chord of the disk.

According to still further features in the described preferred embodiments the ionizing radiation comprises X-ray radiation.

According to still further features in the described preferred embodiments the ionizing radiation comprises gamma ray radiation.

According to still further features in the described preferred embodiments the ionizing radiation comprises electron beam radiation.

According to still further features in the described preferred embodiments the ionizing radiation comprises nuclear particle radiation.

According to still further features in the described preferred embodiments the ionizing radiation creates free electrons in the material.

According to still further features in the described preferred embodiments the ionizing radiation is continuous ionization radiation.

According to still further features in the described preferred embodiments the ionizing radiation is pulse ionization radiation.

In accordance with a one of preferred embodiment of the present invention, a patterned object with feature dimensions in the range of 500 nm or smaller (for example microelectronic optical lithography object) is placed on storage phosphor surface and irradiated by X-ray creating patterned into phosphor. This pattern is stored into phosphor as a latent image of the object. This latent image is presented as electron and hole centers concentration, which is proportional to X-ray intensity, transmitted through the object. The latent image of the object is stable in dark or in the absence light from spectral range of the absorption of the electron centers.

In the phase of the readout of a storage radiation image the phosphor is placed on reading out platform of the near-field luminescence microscope and is illuminated (photostimulated) for example through tapered pipette as it disclosed in U.S. Pat. No. 4,917,462 or tapered fiber tip as it is disclosed U.S. Pat. No. 5,410,151, both called father as light source. The photostimulating light wavelength is chosen in the spectral range of the absorption of the electron centers to cause to recombine electrons with hole centers. As a result the photostimulation light is emitted with intensity proportional to electron and hole centers concentration.

The physical principle underlying the near field luminescence microscope is illustrated in FIG. 1. The stimulation light with wavelength λ₁ depicted by thick arrow is passing through tapered pipette or fiber with opening diameter smaller than wavelength transmitted through. This stimulation light emanating through aperture depicted by thin solid arrows remains collimated in the shape of the aperture to a distance of about one-half of the opening diameter. This region is called near-field region. At the distances great than wavelength the strong light divergence is occurred. This region is called far-field region. The photostimulation luminescence depicted by doted arrows possess the same properties having near field region in the both side of emanating layer and conventional far field regions. Part of near-field photostimulation luminescence is transmitted back by pipette (or other such kind of devices) and may be registered as near field photostimulated luminescence by appropriate detector.

Energy flux transmitted through tapered pipette (fiber) decrease in intensity with increasing distance from the source. That means that the distance between light source and photostimulable phosphor must be preserved with accuracy of about 20 nm (z-direction). It is equally necessary to obtain accurate positioning in x and y directions (in the plane of the phosphor), since the size of the steps taken during scanning the in the x and y directions limits the resolution of such systems. The step size during a scan should be shorter than one-half of the desired resolution, so a system designed for 50 nm resolution must include positioning control of better than 25 nm in the x and y directions devices).

The light emitting from photostimulable phosphor is weak enough to require the sensitive detection electronics such as PM. Signal to noise ratio may by increased by means of a different electro-optic methods such as pulse stimulation and pulse registration method.

In another preferred embodiment of present invention the tested object is the distance between two surfaces, for example distance between the magnetic head pole and the surface of the rapidly rotating magnetic disk. The flying results from air bearing due to the aerodynamic effect produced by the rigid disc rotation. The flying heights are generally less than 250 nm and trend in the art is toward very low flying heights that is in the range of few tens of nanometers.

Known in the art devices used for this purpose is cold as Flying Height Testers. Almost all these known devices based on optical interferometry as are disclosed for example in U.S. Pat. Nos. 5,218,424; 5,638,178; and 5,781,299. The main disadvantages of known in the art Flight Height Testers is that the interface between the magnetic head and a real hard disc cannot be measured directly by optical interferometry methods. Therefore, there are two methods known in the art one of which perform a relative measurements of the distance between the back surface of the magnetic head and real disk and another method use a transparent glass surrogate disk in place of a real hard disc. The disadvantages of first type of the methods is that the flying high can only be estimated from the position of the back side of the head assuming that head thickness and shape do not changes due to mechanical and thermal stress during the flight. Another disadvantage is that the back of the head is currently not accessible on most production slider assemblies. Direct measurements of the slider—disc interface is realized in another method where the real hard disc is replaced by transparent glass disc and interference patterns receive using different optical scheme modifications. From these interference patterns the distance between magnetic head pole and disk is calculated. One of disadvantages of this method is relatively low accuracy of the distance measurements, which do not exceed ¼ of the wavelength used in measurement. That means that accuracy of these devices is not better than 100 nm for visible light. Another disadvantage of this method is in assumption that the mechanical properties of the glass disc, it smoothness is the same is for real hard disc and, therefore, it is proposed that rotated hard disk drag the air by the same manner as a glass disk. It is obviously that this assumption may lead to significant error in slider/disk distance measurements. Still another disadvantage of known in the art method is the hard disc beatings during his rotation. The amplitude of such beatings may achieve the tens micron. Due these beatings the hard disc-magnetic head distance may slightly changed that cause unsharpened diffraction image and therefore un-precision in flight height estimation.

In the preferable embodiment of present invention X-ray irradiates the slider upon rotated hard disk and radiation image of the magnetic head and it position relatively the hard disk is stored in radiation image storage phosphor. In preferable embodiment of present invention the X-ray wavelength used is in the range of one tens of a nm (about 10 KeV) and is much shorter than the slider/disk interface distance. Therefore the radiation images of the flight height and also orientation of the magnetic head may be measured with extreme precession, limited only by readout method. Using above disclosed by us the near field microscopy technique for readout radiation images the resolution of preferable embodiment is in the vicinity of a 5 nm.

In preferable embodiment of present invention the problem of the disc beatings is easily solved by using shot pulse X-ray irradiation in flight height measuring. The X-ray pulse duration and the X-ray dose may be easily estimated using following simple considerations:

The disc rotation frequency is about 3,000 r.p.m. and rotation period t 300 μsec. During this time disc (and magnetic head) change his position relatively to storage crystal for H μm. H is in the range of tens μm. The X-ray irradiation pulse duration τ is determined by required precision η of a measurement:

$$τ = η \frac{t}{H}$$

For example to preserve the flight height precision η=5 nm if H=10 μm τ must be about 0.1 μsec.

Another advantage of preferable embodiment of the present invention is that the appropriate chose of the position of the X-ray source and radiation image storage screen relatively to the slider allows to one to the enlarge image of the distance between magnetic head and hard disk still increasing the resolution possibility of these embodiment.

In accordance with a preferred embodiment of the present invention, a ionizing radiation acquisition/storage device uses a doped crystal having the following formula:

AⁱB^{vii}:a M (1),

wherein Aⁱ is an alkaline metal, preferably, LI, Na, K, Rb or Cs; B^{vii} is a halogen, preferably, F, Cl, Br or I; and M is an activator ion preferably selected from the group consisting of Eu²⁺ Ge²⁺, Sn²⁺ Pb²⁺, Tl⁺, Ga⁺, and Ag⁺, Cu⁺. The concentration a of the activator M is preferably between 0.1 and 1 m % (i.e., approximately from 10¹⁸ up to 10¹⁹ ions/cm³).

Our experiments have shown that most preferable are crystals KBr activated by In⁺ or by Eu²⁺-ions. These crystals, properly activated, as it described above posses highest photostimulable centers production effectiveness. Our experiments have shown that in crystal KBr:In the energy require for production one electron-hole pair —Eₚ is about 100 eV of X-ray quanta. In crystals KBr:Eu this value of Eₚ is about 30 eV. These values are the lowest from that are known for different activated single crystals described by formula (1). The photostimulable luminescence spectra of this crystal is in the spectral range in the within 400 nm-500 mn that is the in the range of maximal sensitivity of the commonly used PMs. The photostimulation light is in the spectral range of 640 nm that is very close to commercially available He—Ne gas lasers or red diode lasers. It is also established in our experiments that quantum yield of the photostimulated luminescence under He—Ne laser stimulation is close to unit in both these crystals.

Using storage crystal sensitivity Eₚ and photostimulation luminescence quantum yield one can estimate the required X-ray radiation dose:

Standard PM with current amplification coefficient about 10⁶ and anode noise current about 1 nA can measure 5 luminescence quanta, which are impinge the PM's photocathode during 10-6 sec, with signal/nose ratio about 10. These photostimulation luminescence quanta must be collected from one pixel in the reading out process of the radiation image. The collection efficiency of the photostimulated luminescence quanta emitted from storage crystal may achieve up to 80%. That means that electron-hole pairs per pixel must be about 10 to provide signal to noise relation higher than 10. For image resolution 10 nm pixel area must be about 100 nm² and therefore surface concentration of electron-hole pairs must be about 10¹³ pair/cm². For 1 pair production it is necessary about 30 eV energy (see above) therefore the X-ray energy flux E must be in the range 3 10¹⁴ eV/cm².

The number of X-ray photons per cm² per 1 roentgen at X-ray quanta energy 10 keV is 10⁹ photons/cm and energy flux is 10¹³ eV/cm² (see for example R. H. Herz “The Photographic Action Of Ionization Radiations”, p 150 (1969), Wiley-Interscience, NY, London Sydney, Toronto). That means that X-ray dose must be about 30 R for reading out signal noise ration be about 10, this dose is very real for all known X-ray sources working weather in CW or pulse regime.

Preferably, the phosphor material is a single doped alkali-halide crystal. However, an any other transparent phosphor is used in other preferred embodiments.

It is preferable that the thickness of the crystal layer in which the radiation image is written in is in the range of 1000 nm or less for better photostimulation image resolution. In accordance to the preferable embodiment of the present invention the to achieve this object two steps comprises:

(1). Using the energy of X-ray quanta in the range 5 keV-10 keV. This is due to strong dependence of the X-ray penetration depths on X-ray quanta energy. These dependencies are shown in FIG. 2 for some known in the art phosphors. The penetration depth D (is estimated as depth into the material at which the X-ray radiation intensity is diminished for e times e.g. D=1/μ where μ is X-ray absorption coefficient in cm⁻¹. The low energy of the X-ray used in preferred embodiment of the present invention increase also sharpness of the image of the inner structure of the tested object due to higher X-ray absorption by tested object for lower X-ray quanta energy.

(2). Using surface doped single crystals as a photostimulable phosphor.

A preferred method of producing a surface doped crystal comprises:

(a) contacting one face of an undoped crystal with a dopant; and

(b) heating the crystal and doping material for a given period of time at a given temperature.

The temperature and time period are dependent on the desired thickness of the doping layer, the dopant and the form of the dopant. Typically, the temperature is below the melting temperature of the crystal. The dopant at the process of the activation may be in the form of a gas or in the form of a deposited on crystal surface thin layer of a dopant.

### BRIEF DESCRIPTION OF THE DRAWINGS

FIG. 1 is a light rays propagation scheme model utilized in the near field photostimulated luminescence readout method.

FIG. 2 is a graph showing the dependencies of an X-ray quanta absorption coefficients and penetration depth on quanta energy for known in the art phosphor (BaFBr:Eu) and transparent single crystals RbBr and KBr according to a preferred embodiment of the present invention.

FIG. 3a is a one of the preferred embodiment of the present invention employing a setup of writing in a radiation image of an object.

FIG. 3b is a one of the preferred embodiment of the present invention employing setup of read out of a radiation image.

FIG. 4 is an example of the dependencies of a linear X-ray absorption coefficient for gold (solid line), contrast function for 50 nm thin gold layer (doted line) and air transmission (dashed line) on the X-ray quanta energy are shown.

FIG. 5 is geometry view of the formation of the penumbra (latent image) for sub-micro object with feature dimensions smaller than the focal spot of the X-ray source.

FIG. 6 is a cross-sectional view of a typical storage crystal and a number the far-field photostimulation luminescence light rays propagating through the crystal.

FIG. 7a is an alternative read out embodiment of the invention shown in FIG. 3b illustrating the placement of the photodetector to the back side of the storage phosphor for the purpose to utilize far-field photostimulation luminescence propagating to the opposite direction to photostimulation light.

FIG. 7b is an another alternative read out embodiment of the present invention illustrating the using the wave guide effect of the photostimulation luminescence light propagation through transparent photostimulable crystal.

FIG. 7c is still another alternative light collection system for far-field photostimulated luminescence for read out embodiment of the present invention utilized not imaging light collection system such as parabolic or elliptic mirror or mirror systems

FIG. 8a is a preferred embodiment of the present invention employing a setup of writing in a radiation image of a optical gap between two surfaces specially for flying height measuring.

FIG. 8b is a disk shown in FIG. 8a from the top, indicating the position of the magnetic head relating to the magnetic disk.

FIG. 9 is a view of geometry of the formation of the penumbra (latent image) for small gaps between two surfaces specially for magnetic head—magnetic disk surfaces.

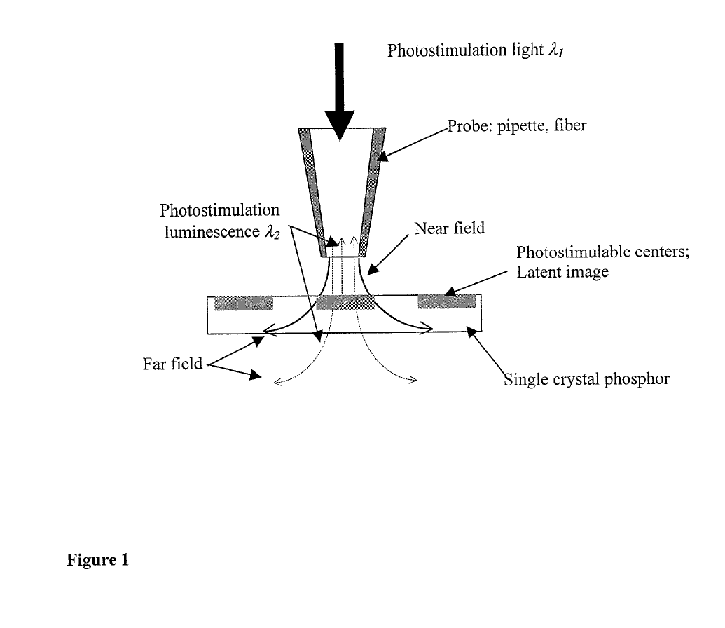

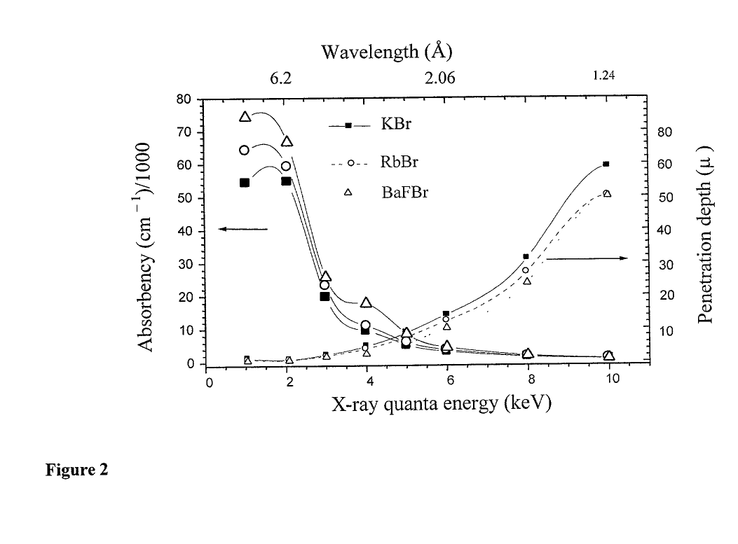

### DETAILED DESCRIPTION OF THE PREFERRED EMBODIMENTS

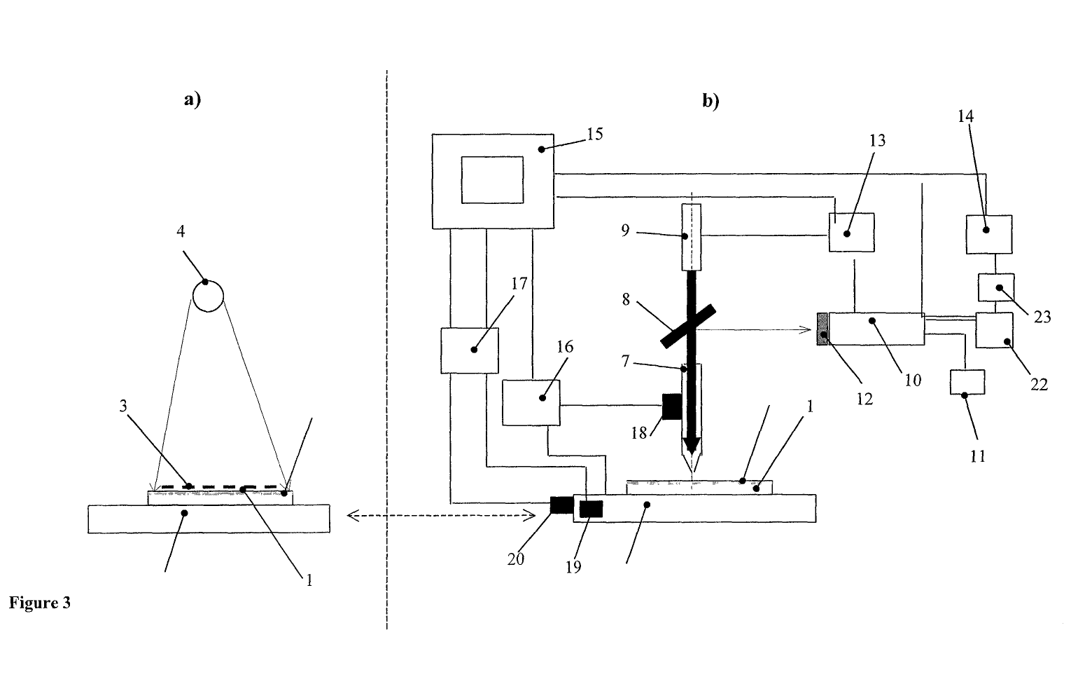

FIG. 3a shows all one of the preferred embodiment of the present invention employing a setup of writing in a radiation image of an object (3) which placed on the surface of the photostimulable single crystal phosphor (1) with thin activated layer (2). X-ray irradiates the sample from X-ray device 4. This irradiation produces the latent image (6) (see FIG. 3b) of the object (3) in the form of the concentration distribution of the electron and hole centers patterned by the object.

In preferred embodiment of the present invention, where measured signal is proportional to X-ray intensity transmitted through tested object, the image contrast T is defined as

$$T = \frac{{I}_{max} - {I}_{min}}{{I}_{max} + {I}_{min}} , \qquad ( 1 )$$

where Iₘₐₓ and Iₘᵢₙ are the maximal and minimal X-ray intensity transmitted through the object.

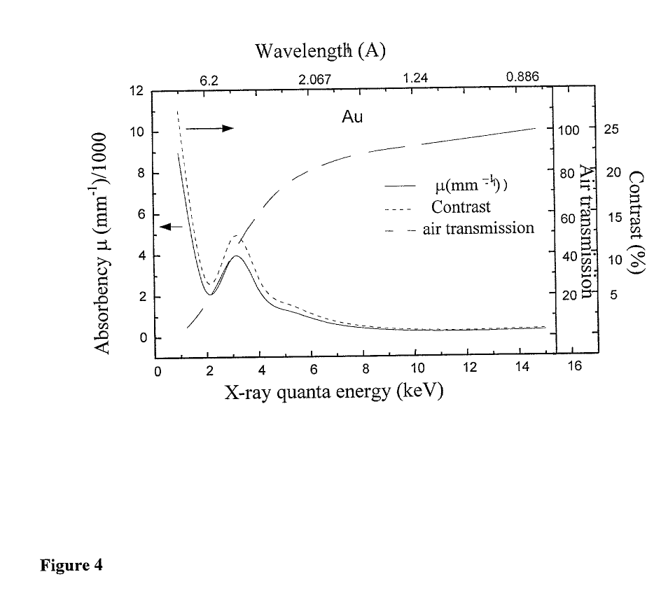

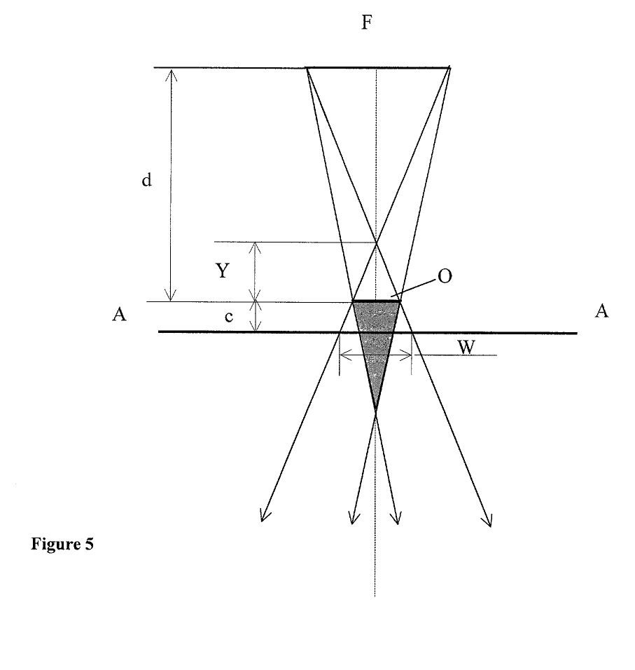

In order to achieve the maximal contrast, it is preferable in this embodiment that the X-ray quanta energy would be chosen such that X-ray absorption in the object is as large as possible still preventing high X-ray absorption in the air. In FIG. 4 the example of the dependencies of a linear X-ray absorption coefficient for gold (solid line), contrast function for 50 nm thin gold layer (doted line) and air transmission on the X-ray quanta energy are shown. From this picture it is obviously that the X-ray quanta energy preferable to be in the region of about 4-5 keV. In this energy range there is the maximum absorption of the gold due of K absorption edges and therefore imaging contrast is higher than 10%, and still about 50% of the X-ray quanta are transmitted through 5 cm thickness of air.

Now we will consider the geometry of the formation of the so called half shadow image or penumbra for object with linear dimensions smaller than X-ray source focal spot diameter.

The diameter of focal spots in real X-ray apparatus ranges from about 0.1 to about 3 mm and size of the objects we intend to imagine ranges from about 50 nm up to 1000 nm. In FIG. 5 it is shown the geometry of the formation of the penumbra (half a shadow image) of the thin objects into the photostimulable phosphor. In this FIG. 5F is a diameter of the focal spot of the X-ray device (4), O is the smallest dimension of the object, d is the focus—object distance, c is the object—photostimulable phosphor distance and W is the size of the image.

It is important to calculate the actual total width W of the imaging. The calculation is carried out using following elementary geometric consideration based on FIG. 5.

$$\begin{matrix}\frac{F}{d - Y} = \frac{O}{Y} \\ and & ( 1 ) \\ Y = \frac{dO}{F + O} & ( 2 )\end{matrix}$$

The total width W of the image at any given image plan such as AA, or others, follows from

$$\begin{matrix}\frac{W}{O} = \frac{c + Y}{Y} \\ and & ( 3 ) \\ W = \frac{O ( c + Y )}{Y} & ( 4 )\end{matrix}$$

By submitting value for Y we have

$$W = \frac{O ( c + \frac{dO}{F + O} )}{\frac{dO}{F + O}} = \frac{O ( c + d ) + cF}{d} \qquad ( 5 )$$

In the some case (for example in lithography) of the parameters which are c=1 μm, d=100 mm, and F=0.1 mm the total width W of the radiation image with size 50 nm will be 50 nm. The actual image width in the phosphor is also influenced by thickness of the phosphor layer and electron-hole centers production process and it is usually appear to be slightly greater that the calculated width W. It is seen from these estimations that image resolution much higher than 50 nm may be achieved in this preferred embodiment.

After recording a radiation image of the object, the stage (5) with photostimulable phosphor (1) (FIG. 3a) is moved to the readout position of a near-field luminescence scanning microscope schematically setup of which is shown in FIG. 3b. The pipette (7) (or optical fiber, or sub-micron aperture) with tapered tip is adjacent to the single crystal phosphor with written radiation image (6). This pipette is used as near field excitation source and as photostimulated light transmitter to the light detector (10), preferable the (PM) with his power supplier (11). The light beam from the He—Ne laser or diode laser or ally other appropriate light source (9) through dielectric mirror (8) excites photostimulation luminescence into the photostimulable phosphor (1) in the previously irradiated region (6). The photostimulation light partly retransmitted by the pipette (fiber) (7) toward a PM (10) through optical filter (12). This filter blocks the photostimulated light and allow the photostimulation luminescence light to be transmitted to the detector.

Light source driver (9) is connected to driver (13). Electric signal from PM (10) is amplified (block (22)) and through low pass filter (23), analog-digital converter (14) is fed to PC (15) and may be displayed as radiation image of the object.

To increase signal to noise ratio of measuring method light source (9), driver (13), driver (17), PM (10) and amplifier (22) are synchronized by PC (15).

The stage (5) is moved in precise steps in x and y directions by transducers (19) and (20) controlled by PC (15) through driver (17). These scanning steps are synchronized with stimulating light through light source driver (13) by PC (15). The near field pipette tip—photostimulable phosphor distance is preserved with grate precision using tunneling current closed loop circuit (16). For this purpose stage (5) and part of the photostimulable phosphor must be coated with thin conducting layer providing tunneling current means. In another embodiment of present invention the z-direction distance is monitored by atom force microscope approach (not shown).

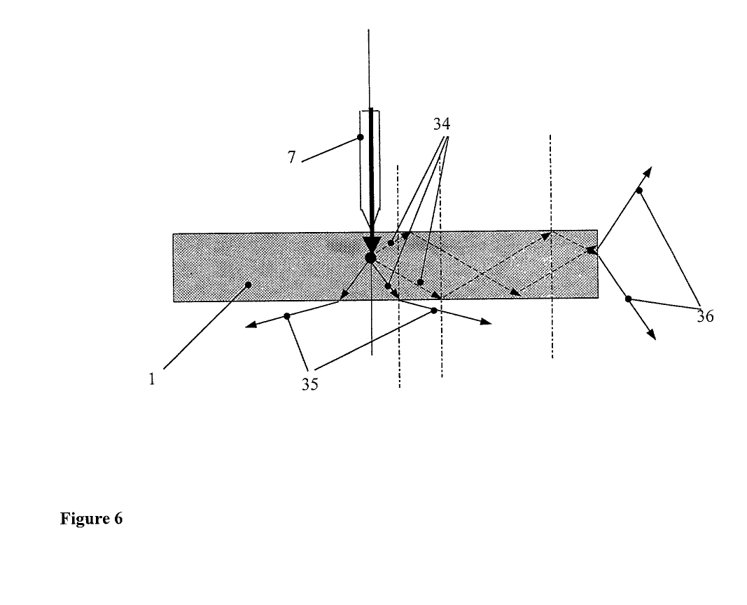

In another preferred embodiment of the present invention the far-field part of the photostimulation luminescence is utilized for radiation image reconstruction. In FIG. 6 is shown a cross-sectional view of a typical storage crystal (1) and a number the far-field photostimulation luminescence light rays (30) propagating through the crystal. Photostimulation light rays (30) radiate at various angles, which may be greater than, less than or equal to the total internal reflection angle. This critical angle α_{c} is determined by crystal refraction coefficient n and is equal:

α_{c}=arcsin(1/n) (6)

For example we consider the case in which KBr crystal is used as transparent photostimulable phosphor. The refraction coefficient of this crystal is 1.56 and the α_{c}=39.9°. That means that far-field photostimulated luminescence ray cone designated (32) that may be emitted from back surface of the crystal phosphor has about 80° angle at the apex (2α_{c}) and about 22% if photostimulated light may be registered from back surface of the phosphor. The photoluminescence rays designated (33) which are emitted under angle grate than α_{c} propagate through crystal under total reflection condition as it is occur in optical wave guides and may be registered from the side surfaces of the crystal phosphor.

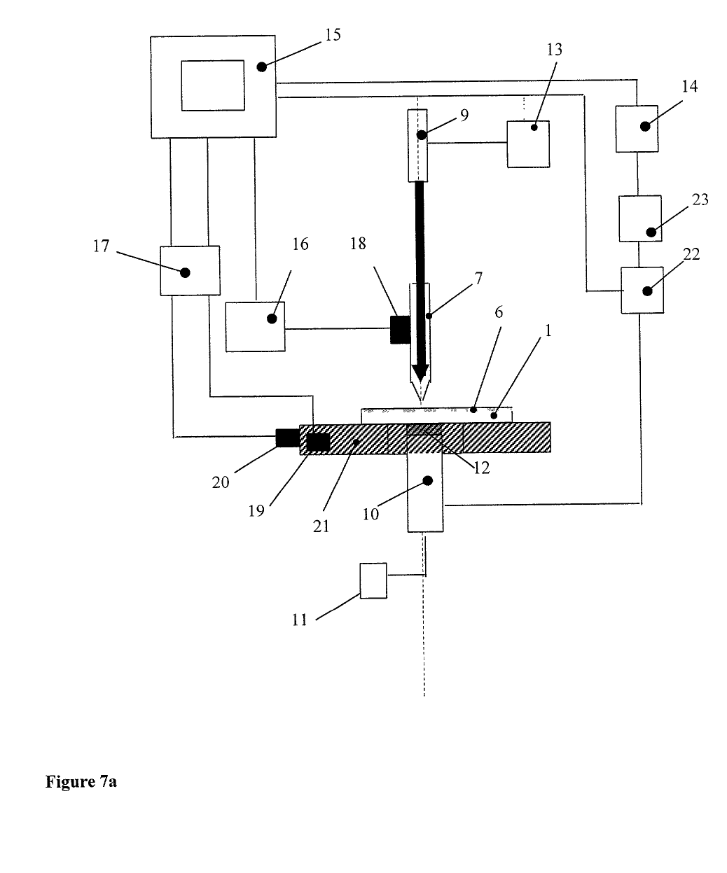

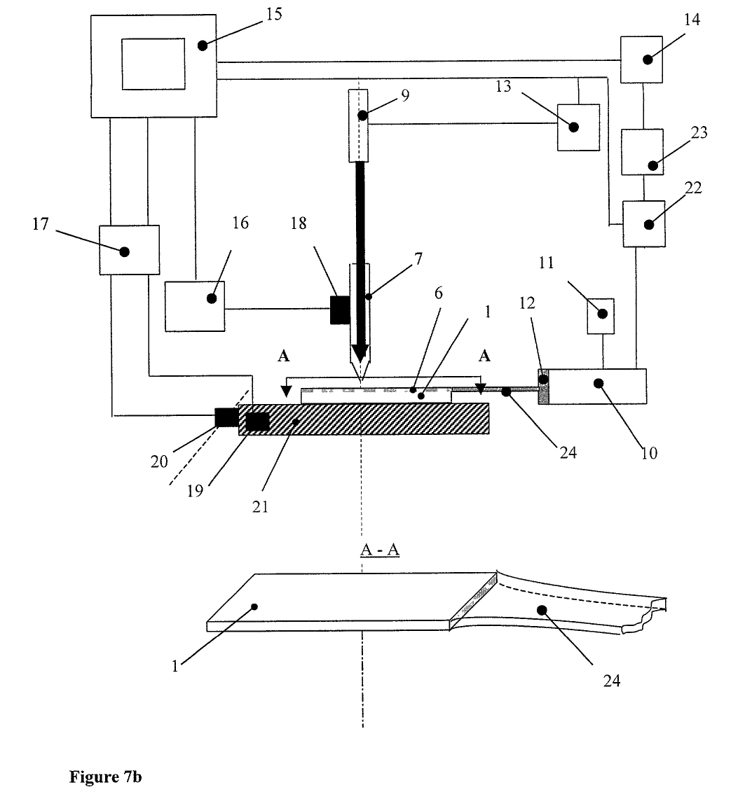

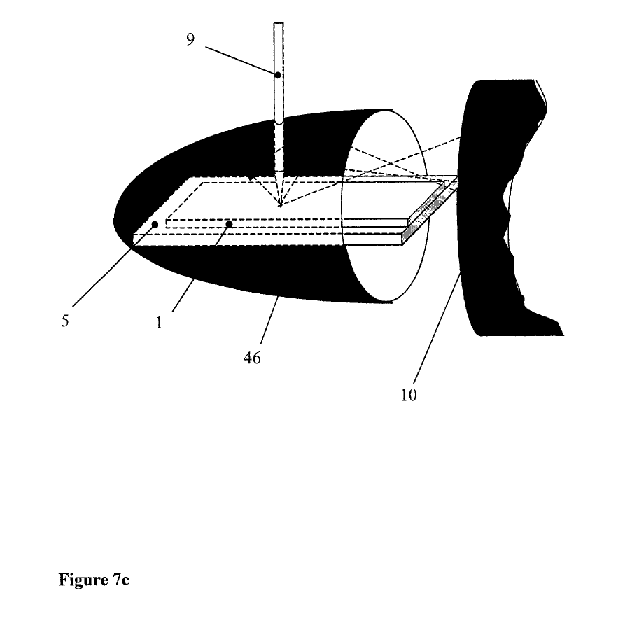

In FIG. 7a is shown the schematically setup of preferred embodiment of readout system for read out from the back surface of the phosphor utilizing light rays (30) shown in FIG. 6. The same type of the scanner, photostimulation light optics and electronic elements as depicted in FIG. 3b is used in this embodiment. The cutoff filter (12) and PM entrance window is placed in close vicinity of the photostimulable phosphor back surface. In another embodiment (FIG. 7b) of the present invention the photostimulation luminescence is registered from side surfaces of the storage crystal utilizing waveguide effect of the transparent single crystal (luminescence rays (31) in FIG. 6)). The scanning and photostimulation systems remain as depicted in FIG. 3b. To allow the free X-Y directions moving of the stage (5) the photostimulation luminescence light transmitted to the photodetector (PM) through flexible optical wavegades depicted (24). In still another embodiment of the present invention the photostimulable phosphor (1) on stage (5) is placed into non-imaging light collection system such as elliptic or parabolic mirror depicted (36). This embodiment is shown in FIG. 7c.

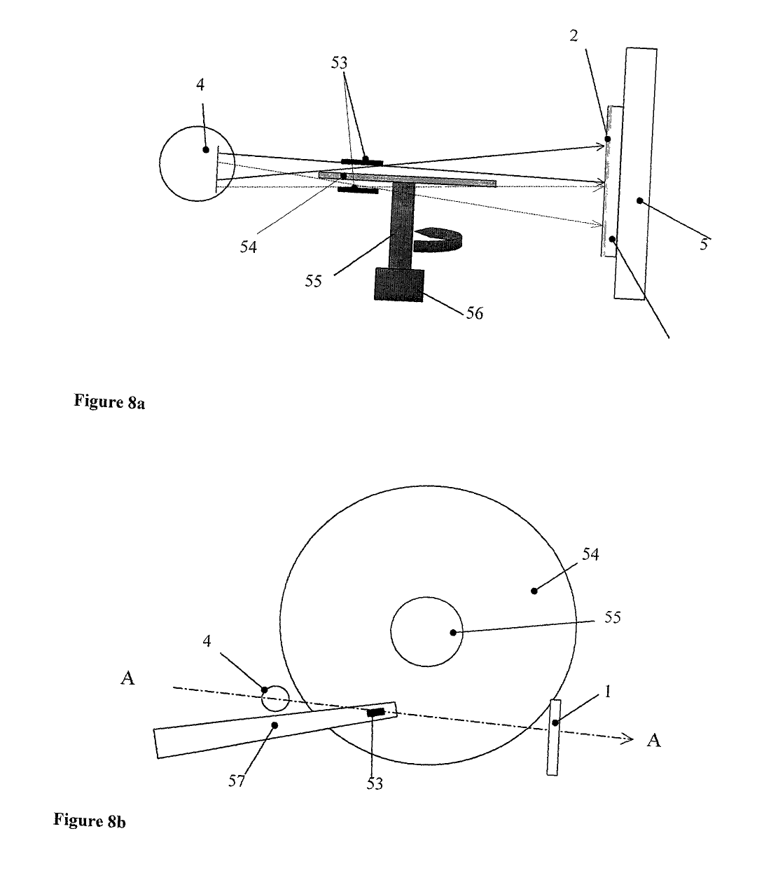

FIG. 8a shows still another preferred embodiment of the present invention employing a setup of writing in a radiation image of a small spacing and particularly for flying height imaging. The magnetic heads (23) is in nearly contact with rotating magnetic disc (24) Disk (24) attached to a spindle (25) driven by motor (26), so the size of the gap may be written as function of the speed rotation of a disk (24). The position of the magnetic head with the respect to a spindle (25) is shown in FIG. 8b as top view of the FIG. 8a where the mechanical arm (26) is shown also.

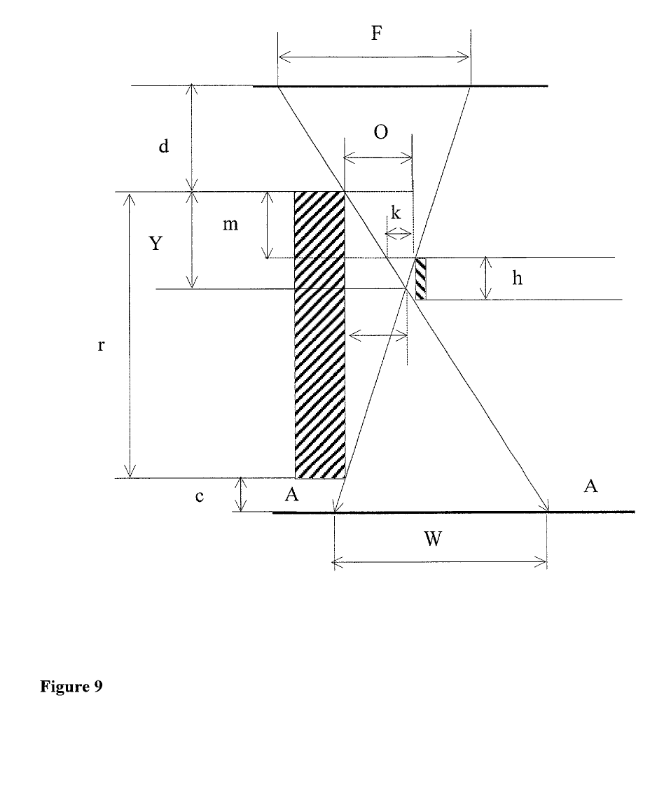

The radiation image geometry consideration of the object—disk gap imaging is presented in FIG. 9 where F is a diameter of the focal spot, O is the distance between object and disk, d is the X-ray tube focus—disk distance, h is the length of the object in the direction of X-ray propagation (A-A direction in FIG. 8b), r is the disk sector chord length, c is the disk—memory crystal distance and m is the disk—object distance. The other distances are clear from this FIG. 9. The actual total width W of the gap imaging may be easily estimated using following simple considerations

$$\frac{t}{r} = \frac{O - t}{h} , and t = \frac{rO}{h + r} ( ) , \\ \frac{Y}{t} = \frac{m + h}{O} , and Y = \frac{r ( m + h )}{h + r} ( )$$

$$\frac{k}{h} = \frac{O}{m + h} , and k = \frac{Oh}{m + h} ( )$$

$$\frac{W}{k} = \frac{r - Y + c}{Y - m} and$$

$$W = k \frac{r + c - Y}{Y - m} ( )$$

Inserting into equation ( ) values k and Y we have

$$W = \frac{O}{m + h} \frac{( r + c ) ( r + h ) - r ( m + h )}{r - m} ( )$$

Now we can estimate the value of the real gap O radiation imaging width W. For example the gap width O=10⁻⁴ mm (100 nm), disc chord length where is placed magnetic head, (see FIG. 4b) r=100 mm; the distance from magnetic edge to the magnetic head in m=30 mm; length of the head h=1 mm, and X-ray focus—disc and storage crystal—disc distances and c=1 mm. Putting these values into equation ( ) W 3 10⁻⁴ mm.

In a modern hard disc systems the magnetic head is placed on two opposite sides of the magnetic disc as it is shown in FIG. 8a. In preferable embodiment of the present invention the position of the X-ray system relative the magnetic disc is chosen such that both distances between disc and two magnetic heads are written into the storage crystal phosphor.

The read out of the storage radiation image is produce using one of the reading out method shown in FIGS. 3b, 7a, 7b, and 7c.

The invention thus described it will be obvious that the invention may be varied in many ways. While certain examples have been described and shown in complaining drawings, it is to be understood that such embodiments are merely illustrative and not restrictive on the broad variation of other embodiments of present invention, and that this invention not be limited to the specific constructions and arrangements shown and described. For example instead X-rays and any other ionization radiation which produce electron and hole centers into transparent phosphor may be used. It may be high energy UV light, radiation from radioisotope (e.g. a Co⁶⁰ source), high energy particles source.

What is claimed:

1. A method writing in and reading out a sub-micron quality radiation image of an object under test, comprising;
irradiation of the object under test, by means of ionization radiation means, to produce said object patterned through ionization radiation passed through said object;
having a photostimulable material been irradiated by said patterned ionization radiation passed through said object for creating pattern concentration of the electron and hole centers;
photostimulating said material with stimulating light to create election hole recombination to create photostimulation patterned luminescence; and
collecting of said stimulating luminescence light to produce an electronic image signal.

2. A method according to claim 1, wherein said photostimulable material is transparent to the photostimulation and to the photostimulation luminescence light.

3. A method according to claim 1, wherein said photostimulable material is transparent to the photostimulation and to the photostimulation luminescence light wherein the transparent photostimulable material is a doped single crystal having the following empirical formula;
AⁱBⁱⁱ:aM
wherein;
Aⁱ is an alkaline metal selected from the group consisting of, LI, Na, K Cs, and Rb,
Bⁱⁱ is a halogen selected from the group consisting of F, Cl, Br or I;
M is an activator ion selected from the group consisting of Eu²⁺, Ge²⁺, Sn²⁺ Pb²⁺, Tl⁺, In⁺, Ga⁺, and Ag⁺, Cu⁺,
and concentration a of the activator M is between 0.1 and 1 m %

4. A method according to claim 1, wherein said photostimulable material is a thin surface activated single crystal transparent to the photostimulation and to the photostimulation luminescence light.

5. A method according to claim 1, wherein said photostimulable material is a thin surface activated single crystal transparent to the photostimulation and to the photostimulation luminescence light, M is an activator ion selected from the group consisting of Eu²⁺ Ge²⁺, Sn²⁺ Pb²⁺, Tl⁺, In⁺, Ga⁺, and Ag⁺, Cu⁺, wherein a surface activation of said transparent single crystal is achieved by diffusion of an activator M.

6. A method according to claim 1, wherein said photostimulable material is a thin surface activated single crystal transparent to the photostimulation and to the photostimulation luminescence light and wherein a manufacturing of said surface activated transparent single crystal comprises the steps of;
a) vacuum vapor-depositing activating metal ion M on surface of a transparent phosphor;
b) heating vapor-deposited stimulable single crystal in the vacuum or under a protective gas atmosphere up to a temperature slightly less than the melting point of the stimulable single crystal;
c) heating stimulable single crystal and vapors of the activator or activator salts in the vacuum or under a protective gas atmosphere up to a temperature slightly less than the melting point of the stimulable single crystal.

7. A method according to claim 1, wherein said photostimulation comprises;
a) laser beam source emitted said stimulation light within the spectral range of 500 nm to 700 nm
b) near field light delivery system to stimulate of said photostimulable material.

8. A method according to claim 1, wherein said photostimulation comprises;
a) laser beam source emitted said stimulation light within the spectral range of 500 nm to 700 nm
b) near field light delivery system to stimulate of said photostimulable material;
wherein said near field stimulation light delivery system comprises;
c) mask incorporating at list one aperture having diameter within the range of 1 nm to 5 nm or
d) pipette with tapered tip with opening aperture diameter within the range of 1 nm to 5 nm; or
e) optical fiber with taped output tip with diameter within the range of 1 nm to 5 nm.

9. A method according to claim 1, wherein said photostimulation further comprises the steps of controllable positioning said photostimulable crystal irradiated surface to near-field distance z from an aperture or a fiber output tip being used in a near field light delivery system that is used to stimulate of said photostimulable material.

10. A method according to claim 1, comprising a further step of x-y plane scanning of said photostimulable crystal with respect to an aperture or a fiber output tip being used in a near field light delivery system that is used to stimulate of said photostimulable material.

11. A method according to claim 1, comprising;
a) the step of using a current closed loop circuit to keep the preserve of a near field distance between an aperture or a fiber output tip being used in a near field light delivery system that is used to stimulate of said photostimulable material, and between said photostimulable crystal;
b) the step of using of X-Y stage having X-Y stage driver to move said photostimulable crystal and to produce raster pattern of photostimulation luminescence radiation image of said object.

12. A method according to claim 1, further comprising the step of converting photostimulation luminescence light to electric signal, and the step of visualization said electrical signal.

13. A method according to claim 1, further comprising the step of converting photostimulation luminescence light to electric signal, and the step of visualization said electrical signal, wherein the means for converting photostimulation luminescence light to electric signal is photomultiplier (PM) which is located to opposite side of an irradiated surface of said photostimulable crystal to collect photostimulation luminescence light rays which propagate in this direction through said transparent photostimulable crystal.

14. A method according to claim 1, further comprising the step of converting photostimulation luminescence light to electric signal, and the step of visualization said electrical signal, wherein the means for converting photostimulation luminescence light to electric signal is photomultiplier (PM) which is located to opposite side of an irradiated surface of said photostimulable crystal to collect photostimulation luminescence light rays which propagate in this direction through said transparent photostimulable crystal, and said PM is placed to the back side of said photostimulable crystal perpendicularly to the said irradiated surface of said photostimulable crystal to collect photostimulation luminescence light rays which propagate through said transparent photostimulable crystal under as through optical waveguide.

15. A method according to claim 1, further comprising the step of converting photostimulation luminescence light to electric signal, and the step of visualization said electrical signal, wherein the means for converting photostimulation luminescence light to electric signal is photomultiplier (PM) which is located to opposite side of an irradiated surface of said photostimulable crystal to collect photostimulation luminescence light rays which propagate in this direction through said transparent photostimulable crystal, and said PM is placed in the focus of non-imaging light collection device to collect photostimulation luminescence light rays which propagate through said photostimulable crystal.

16. A method according to claim 1, wherein the sub-micron object to be tested according to claim 1, is a lithographic mask which is placed on close proximity of activated surface of said photostimulable crystal and said photostimulable crystal is irradiated through said object.

17. A method according to claim 1, wherein the sub-micron object to be tested according to claim 1, is a biological molecular object which is placed on close proximity of an activated surface of said photostimulable crystal and said photostimulable crystal is irradiated through said object.

18. A method according to claim 1, wherein the sub-micron object to be tested according, is a gap between computer hard disk and magnetic head and said ionization radiation source, said gap and said photostimulable crystal are positioned in the line which is the chord of said disk

19. A method according to claim 1, wherein said ionizing radiation comprises X-ray radiation.

20. A method according to claim 1, wherein said ionizing radiation comprises gamma ray radiation.

21. A method according to claim 1, wherein said ionizing radiation comprises electron beam radiation.

22. A method according to claim 1, wherein said ionizing radiation comprises nuclear particle radiation.

23. A method according to claim 1, wherein said ionizing radiation creates free electrons in said material.

24. A method according to claim 1, wherein said ionizing radiation is continuous ionization radiation

25. A method according to claim 1, wherein said ionizing radiation is pulse ionization radiation.
